(19) United States
(12) Patent Application Publication
(10) Pub. No.: US 2011/0068615 A1
(43) Pub. Date: Mar. 24, 2011

(54) GUIDE ELEMENT FOR A SAFETY BELT

(75) Inventors: Armin ROSSMANN, Mauchenheim (DE); Sacha TIPPL, Leutenbach (DE)

(73) Assignee: GM GLOBAL TECHNOLOGY OPERATIONS, INC., Detroit, MI (US)

(21) Appl. No.: 12/822,966

(22) Filed: Jun. 24, 2010

(30) Foreign Application Priority Data
Jun. 26, 2009 (DE) 102009030834.2

(51) Int. Cl. B60R 22/00; B65H 23/04

(52) U.S. Cl. 297/483; 242/397

(57) ABSTRACT

A guide element is provided for a safety belt that is fixable on a motor vehicle seat in a shoulder area. A hook, which is open on top, originates from a fastening plate associated with the motor vehicle seat.

### CROSS-REFERENCE TO RELATED APPLICATION

This application claims priority to German Patent Application No. 102009030834.2, filed Jun. 26, 2009, which is incorporated herein by reference in its entirety.

### TECHNICAL FIELD

The invention relates to a guide element for a safety belt, which is fixable in a shoulder area on a motor vehicle seat, a motor vehicle seat having a guide element, and a motor vehicle having a motor vehicle seat.

### BACKGROUND

DE 10 2005 017 123 A1 discloses a vehicle seat, with which a safety belt device having a belt strap is associated in the installed state in the motor vehicle. A retention element is situated on the vehicle seat, using which a component of the safety belt device can be held in the grip area of a seat user seated on the vehicle seat in the non-applied state of the safety belt device. The retention element is implemented in such a manner that it can be displaced into various predefined positions. This retention element only contributes to the comfort of the seat user and does not provide any safety-relevant contribution.

It is at least one object of the invention to provide a guide element of the type cited at the beginning, which contributes both to the simplified handling of a safety belt and also to the safety in the case of a collision—a crash. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics are achieved in the case of a guide element in that a hook which is open on top originates from a fastening plate associated with the motor vehicle seat.

Because of the simple hook for guiding the safety belt, the safety belt can be guided relatively freely and nonetheless exercise its safety function in an emergency situation. If a person is not located on the motor vehicle seat having the guide element, its hook can simply hold the safety belt so it can be unhooked for easy reach ability, and if a person is seated on the motor vehicle seat with applied safety belt, the hook prevents the safety belt from slipping off, in particular downward, if the person is comparatively small, for example, and the motor vehicle seat does not form a hold for the safety belt. Of course, the fastening plate is associated with the motor vehicle seat.

The hook preferably originates from the fastening plate while enclosing an obtuse angle, in particular a right angle. Accordingly, the hook forms an effective support for the safety belt as a function of the installation location of the fastening plate.

The hook is implemented as significantly shorter than the fastening plate. The hook therefore expediently has a length that corresponds to approximately 20% to approximately 50% of the length of the fastening plate.

To fix the guide element on the motor vehicle seat, in one design, the fastening plate is provided with at least one fastener on the side facing away from the hook. For example, the fastening plate may be fixed positively and/or non-positively on a structural part of the motor vehicle seat using the fastener, for example, by screwing, rivet, clipping, or the like.

In one design, the fastener is implemented as a welding dome to be connected to a retention plate. The welding dome of the guide element manufactured from plastic may be connected to the retention plate by ultrasonic or induction welding, for example. Of course, multiple, in particular three welding domes may be shaped onto the fastening plate.

The at least one object, other objects, desirable features, and characteristics are achieved in the case of the motor vehicle seat having the above-explained guide element in that a backrest provided with a covering is implemented as trapezoidal in the shoulder area, i.e., tapers upward.

In such a motor vehicle seat, the problem arises that a relatively large or a relatively small person, in the case of an applied safety belt, is not provided with optimum belt guiding for the greatest possible safety in the case of a collision—a crash—if no guide element or a closed guide element is provided. The applied safety belt is prevented from sliding downward over the incline of the backrest in the shoulder area and the safety belt is simultaneously free upward by the hook, which is open on top, of the guide element.

According to an embodiment, a head rests adjoins the backrest in one piece. Accordingly, the motor vehicle seat implemented as a shell seat has a sporty visual appearance.

The guide element is expediently held on a structural part or the covering of the motor vehicle seat. The covering is preferably provided with holes for the welding domes of the fastening plate, the welding domes being welded to the retention plate situated on the rear of the covering.

In order to achieve optimum belt guiding in connection with the motor vehicle seat, the hook of the guide element preferably extends diagonally upward, in particular at an angle of approximately 45° to the longitudinal axis of the motor vehicle seat.

In the case of a motor vehicle seat having a safety belt device and an above-described motor vehicle seat, the object is achieved according to the invention in that the guide element having its fastening plate forms a support for the safety belt fastened in a belt buckle, i.e., applied, and the hook extends diagonally upward in the direction of a motor vehicle roof, so that an edge of the safety belt presses against the hook.

Accordingly, the hook of the guide element holds the safety belt, which is typically fastened in the area of an outer wall of the motor vehicle seat adjacent to the motor vehicle seat, on the one hand, and to a central console, on the other hand, reliably on the motor vehicle seat. It is assumed that either a relatively small or no person is located on the vehicle seat, because, as already stated, in the case of a relatively large person seated on the motor vehicle seat, the safety belt can come out of the area of the hook and is guided over the shoulder of the person above the guide element.

The motor vehicle seat is expediently implemented as a driver or passenger seat and the guide element is fastened on a door side of the motor vehicle.

An unrolling device of the safety belt device is preferably situated in the area of a B column. In the case of a placement of the unrolling device of this type, the hook of the guide element offers secure guiding of the safety belt over a wide pivot range of the backrest and a large horizontal and vertical movement path of the entire motor vehicle seat.

It is obvious that the above-mentioned features and the features to be explained hereafter are usable not only in the particular specified combination, but rather also in other combinations.

### BRIEF DESCRIPTION OF THE DRAWINGS

The present invention will hereinafter be described in conjunction with the following drawing figures, wherein like numerals denote like elements, and:

FIG. 1 shows a perspective partial illustration of a motor vehicle seat;

FIG. 2 shows a perspective illustration of detail II according to FIG. 1;

FIG. 3 shows a top view of the illustration according to FIG. 2;

FIG. 4 shows a view of the illustration according to FIG. 2 from below; and

FIG. 5 shows a sectional illustration along line V-V according to FIG. 4.

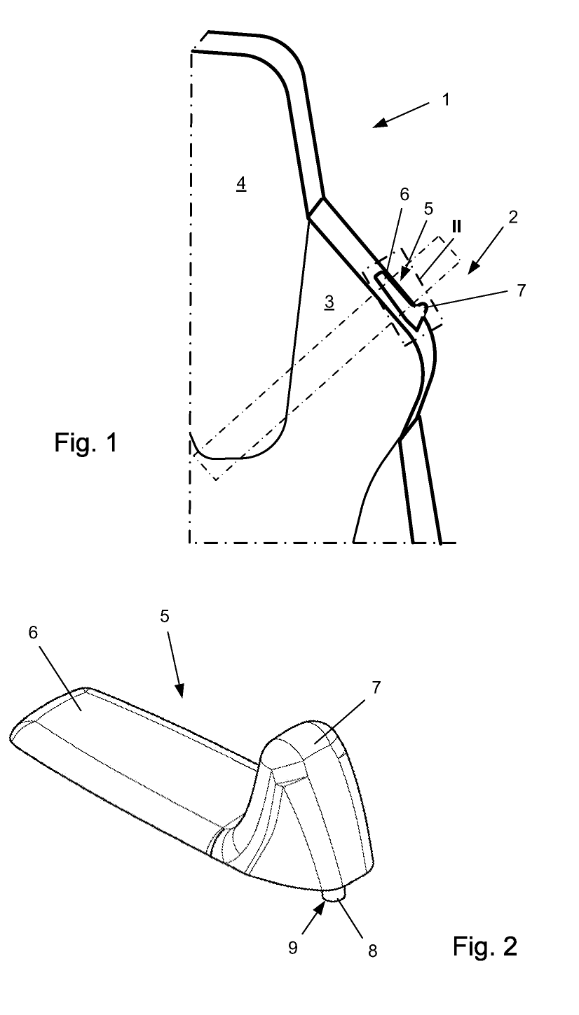

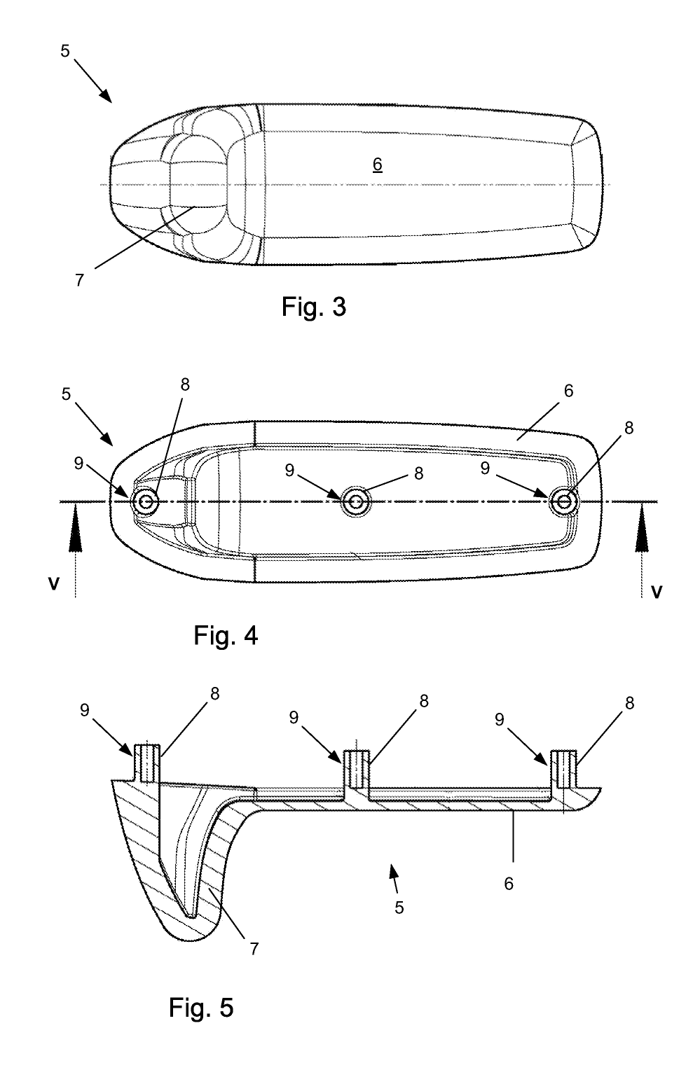

### DETAILED DESCRIPTION

The following detailed description is merely exemplary in nature and is not intended to limit application and uses. Furthermore, there is no intention to be bound by any theory presented in the preceding background or summary or the following detailed description.

The motor vehicle seat 1 comprises a backrest 2, which tapers slightly upward starting from a lower area associated with a seat surface, is subsequently designed somewhat wider again in the lower shoulder area 3, in order to run in a trapezoid toward the head rest 4, i.e., to again taper upward. On the shoulder area 3, which slopes diagonally downward in the direction pointing toward a vehicle outer side, a guide element 5 for a safety belt is installed, which comprises a fastening plate 6, from which an open hook 7 originates. The hook 7 is shaped onto the fastening plate 6 at an obtuse, approximately right angle and is dimensioned significantly shorter than the fastening plate 6. On the side facing away from the hook 7 and facing toward a covering of the backrest 2, the fastening plate 6 is provided with three fasteners 9 implemented as welding domes 8, which are spaced apart from one another at essentially equal distances and are shaped centrally onto the fastening plate 6. To fasten the guide element 5, the welding domes 8, which are cylindrical in cross-section, are guided through the covering of the backrest 2 and connected by welding to a retention plate situated below the covering. In the installed state, the hook 7 extends at an angle of approximately 45° to a longitudinal axis of the motor vehicle seat, so that it originates at an angle of approximately 90° to its support surface in the shoulder area 3.

The guide element 5 forms a support for a safety belt 10 with its fastening plate 6, whose course in the applied state, in which a belt buckle is locked, is indicated by dot-dash line, and an edge 11 of the safety belt 10 presses against the hook 7, which extends diagonally upward in the direction of a motor vehicle roof.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A guide element for a safety belt that is fixable in a shoulder area on a motor vehicle seat;
a fastening plate associated with the motor vehicle seat;
a hook that open on top and originates from the fastening plate.

2. The guide element according to claim 1, wherein the hook is adapted to originate from the fastening plate while enclosing an obtuse angle

3. The guide element according to claim 1, wherein the hook is adapted to originate from the fastening plate while enclosing a substantially right angle.

4. The guide element according to claim 1, wherein the hook has a length that corresponds from approximately 20% to approximately 50% of the length of the fastening plate.

5. The guide element according to claim 1, further comprising a fastener for the fastening plate on a side facing away from the hook.

6. The guide element according to claim 5, wherein the fastener is implemented as a welding dome adapted for connection to a retention plate.

7. A motor vehicle seat, comprising:
a backrest for the motor vehicle seat including a covering having a trapezoidal shape in a shoulder area; and
a guide element for a safety belt that is fixable in the shoulder area, the guide element including a fastening plate associated with the motor vehicle seat and a hook that open on top and originates from the fastening plate.

8. The motor vehicle seat according to claim 7, wherein a head rest adjoins the backrest in one piece.

9. The motor vehicle seat according to claim 7, wherein the guide element is held on a structural component.

10. The motor vehicle seat according to claim 7, wherein the guide element is held on the covering.

11. The motor vehicle seat according to claim 10, further comprising holes for the covering adapted for welding domes of the fastening plate, the welding domes welded to a retention plate situated on a rear of the covering.

12. The motor vehicle seat according to claim 7, wherein the hook of the guide element extends diagonally upward

13. The motor vehicle seat according to claim 7, wherein the hook of the guide element extends diagonally at an angle of approximately 45° to a longitudinal axis of the motor vehicle seat.

14. A motor vehicle seat according to claim 7, wherein the guide element with the fastening plate is adapted to form a support for the safety belt fastened in a belt buckle, and the hook extends diagonally upward in a direction of a motor vehicle roof so that an edge of the safety belt is adapted to press against the hook.

15. The motor vehicle seat according to claim 14, wherein the motor vehicle seat is a driver seat and the guide element is fastened on a door side of a motor vehicle.

16. The motor vehicle seat according to claim 14, wherein the motor vehicle seat is a passenger seat and the guide element is fastened on a door side of a motor vehicle.

17. The motor vehicle seat according to claim 14, further comprising an unrolling device of the safety belt situated in a B column area.
